(19) United States
(12) Patent Application Publication
(10) Pub. No.: US 2016/0071666 A1
(43) Pub. Date: Mar. 10, 2016

(54) Keyboard and Assembly Method Thereof

(71) Applicant: Shenzhen Keyston Technology Co., Ltd, Shenzhen (CN)

(72) Inventor: Dongrui Hao, Yulin (CN)

(73) Assignee: Shenzhen Keyston Technology Co., Ltd

(21) Appl. No.: 14/799,546

(22) Filed: Jul. 14, 2015

(30) Foreign Application Priority Data
Sep. 4, 2014 (CN) 201410448756.2

(51) Int. Cl. H01H 13/7065; H01H 13/88

(52) U.S. Cl. CPC H01H 13/7065; H01H 13/88; H01H 2221/044

(57) ABSTRACT

The invention provides a keyboard and an assembly method thereof. The keyboard comprises a face frame, a multi-link keycap board, a metal shrapnel, a flexible circuit board and a backplane connected successively, the multi-link keycap board is of integrated self-balancing multi-link structure, and multiple keycaps are fixedly arranged on the multi-link structure, the metal shrapnel is of integrated structure, and arc-shaped obstacles are respectively arranged at the corresponding positions of the keycaps, thus realizing the advantages of thin product thickness, good hand feeling, low production cost and high assembly efficiency.

### CROSS-REFERENCE TO RELATED APPLICATIONS

This present application claims the benefit of Chinese Patent Application No. 201410448756.2 filed on Sep. 4, 2014, the contents of which are hereby incorporated by reference.

### FIELD OF THE INVENTION

The invention relates to the technical field of electronic products, in particular to a keyboard and an assembly method thereof.

### DESCRIPTION OF THE RELATED ART

In the current market, the rise of the tablet computer industry brings on increasing market demand for Bluetooth keyboard as well as more requirements for use functions, hand feeling, product thickness, production efficiency and cost. At present, Bluetooth keyboards mainly adopt scissor keyboard and resistive touch keyboard. The scissor keyboard is generally thicker, 3.5 mm to 5 mm, and its keycaps might be knocked off during use, affecting its use functions; in addition, multiple moulds are required for production of the finished products, accordingly increasing costs and lowering product assembly efficiency, thus it is difficult to meet the market demand. The resistive touch keyboard can be up to 1.0 mm to 1.5 mm thick, but users do not have the hand feeling of pressing keys during use, thus the resistive touch keyboard does not conform to the routine habit of users, easily results in misoperation, and is not widely accepted.

### SUMMARY OF THE INVENTION

To overcome the defects in the prior art, the invention provides a keyboard and an assembly method thereof, thus realizing the advantages of thin product thickness, good hand feeling, low production cost and high assembly efficiency.

The invention is realized as follows: a keyboard, comprising a face frame, a multi-link keycap board, a metal shrapnel, a flexible circuit board and a backplane connected successively, the multi-link keycap board being of integrated self-balancing multi-link structure, and multiple keycaps being fixedly arranged on the multi-link structure, the metal shrapnel being of integrated structure, and arc-shaped obstacles being respectively arranged at the corresponding positions of the keycaps.

Further, multiple gaps matching the keycaps are arranged on the face frame, multiple rubber columns are arranged on the lower surface of the face frame, and holes corresponding to the rubber columns are respectively set up on the metal shrapnel, the flexible circuit board and the backplane.

Further, struts are fixedly arranged on the lower end of the keycaps, and the struts are in contact with the arc-shaped obstacles of the metal shrapnel.

Further, the backplane is a metal backplane.

Further, the multi-link structure comprises a side frame and multiple links, the shape of the links is corresponding to the keycaps, and both ends of the links are fixedly connected with the side frame.

Further, an assembly method of the keyboard, comprising step 1: placing the face frame on the desktop in an inverted manner, and placing the multi-link keycap board in the face frame along the axial direction of the gaps of the face frame, allowing the keycaps to be matched and connected with the gaps of the face frame; step 2: placing the metal shrapnel, the flexible circuit board and the backplane on the lower surface of the multi-link keycap board in an inverted manner, and passing the rubber columns of the face frame through holes of the metal shrapnel, the flexible circuit board and the backplane successively; and step 3: heating the rubber columns to melt the rubber columns together with the backplane.

The technical effects of the invention are as follows: the invention provides a keyboard and an assembly method thereof, the keyboard comprises a face frame, a multi-link keycap board, a metal shrapnel, a flexible circuit board and a backplane connected successively. The multi-link keycap board and the metal shrapnel are of integrated structure, and can be molded at one time, thus reducing the moulds cost, and improving the efficiency of production and assembly. In addition, the structure of the keyboard of the invention replaces the scissor structure of a common keyboard, simplifying the structure, and the thickness below 3 mm is available, thus meeting the market demand. Moreover, the metal shrapnel of the invention is of integrated structure, and arc-shaped obstacles are respectively arranged at the corresponding positions of the keycaps, struts are fixedly arranged on the lower end of the keycaps, and the struts are in contact with the arc-shaped obstacles of the metal shrapnel, and the metal shrapnel will produce tactile (i.e., hand feeling) due to compressive deformation during use, which meets the habit of users, thus the keyboard of the invention is widely accepted.

### BRIEF DESCRIPTION OF THE DRAWINGS

To explain the technical scheme in the examples of the invention or in the prior art more clearly, drawings required for description of the examples or prior art will be introduced briefly. Obviously, drawings in the description below are only for some examples of the invention, and other drawings can be obtained by those of ordinary skill in the art without creative work based on the drawings.

FIG. 1 is a decomposition diagram of the whole structure of one example of a keyboard of the invention.

FIG. 2 is a local VI enlarged plan sketch of a multi-link keycap board of the keyboard shown in FIG. 1.

FIG. 3 is a local sectional view of the keyboard shown in FIG. 1 in an assembly state.

### DESCRIPTION OF THE PREFERRED EMBODIMENT

The technical scheme in the examples of the invention will be described in detail in combination with drawings in the examples of the invention. Obviously, the examples to be described are only some examples of the invention, but not all examples. Based on the examples of the invention, all other examples obtained by those of ordinary skill in the art without creative work fall within the protection scope of the invention.

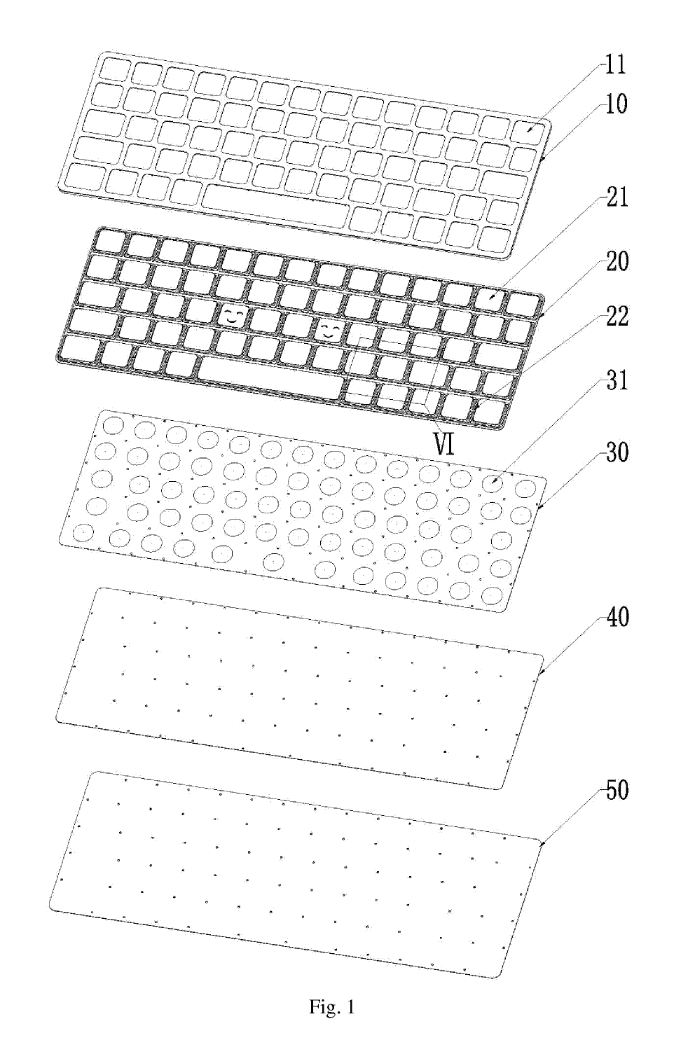

As shown in FIGS. 1-3, the example of the invention provides a keyboard, comprising a face frame 10, a multi-link keycap board 20, a metal shrapnel 30, a flexible circuit board 40 and a backplane 50 connected successively, the multi-link keycap board 20 being of integrated self-balancing multi-link structure 22, and multiple keycaps 21 being fixedly arranged on the multi-link structure 22, the metal shrapnel 30 being of integrated structure, and arc-shaped obstacles 31 being respectively arranged at the corresponding positions of the keycaps 21. The multi-link keycap board 20 and the metal shrapnel 30 are of integrated structure, can be molded in an integrated manner respectively, reducing the production cost and improving the assembly efficiency, and prevent knocking off the keycaps 21 by mistakes during use, prolonging the service life.

Further, as shown in FIGS. 1-3, multiple gaps matching the keycaps 21 are arranged on the face frame 10, multiple rubber columns 12 are arranged on the lower surface of the face frame 10, and holes corresponding to the rubber columns 12 are respectively arranged on the metal shrapnel 30, the flexible circuit board 40 and the backplane 50; struts 211 are fixedly arranged on the lower end of the keycaps 21, the struts 211 are in contact with the arc-shaped obstacles 31 of the metal shrapnel 30, and the backplane 50 is a metal backplane 50.

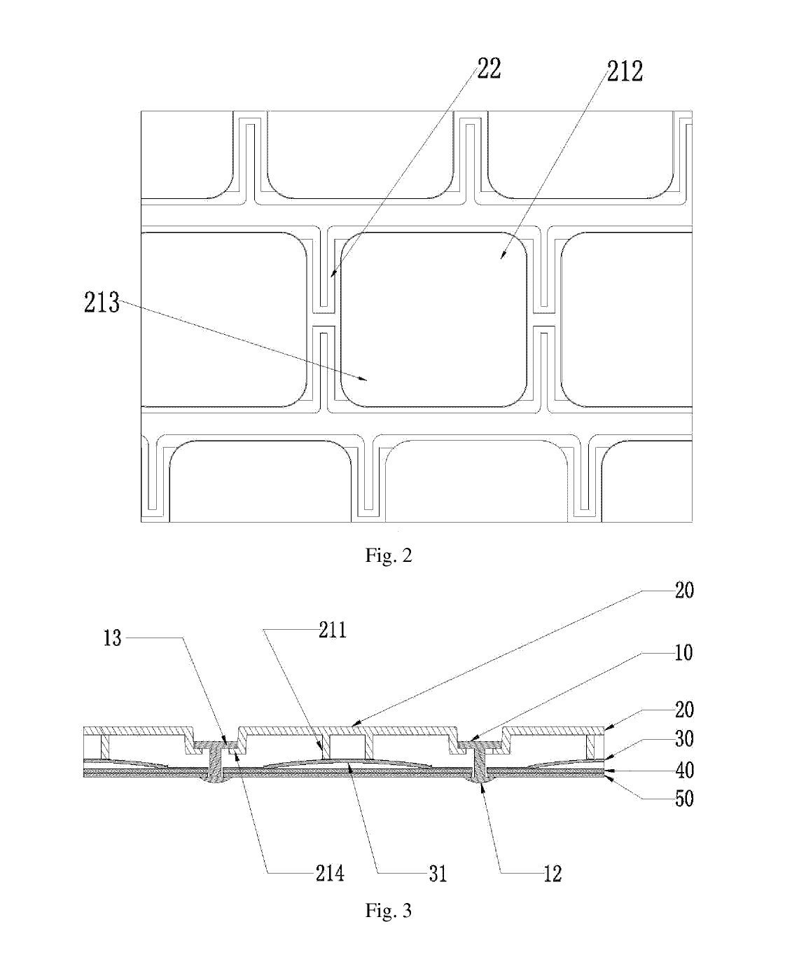

Further, as shown in FIGS. 1 and 2, the multi-link structure 22 comprises a side frame and multiple links, the shape of the links is corresponding to the keycaps 21, and both ends of the links are fixedly connected with the side frame.

As shown in FIGS. 1-3, the assembly method of the keyboard provided in the examples of the invention comprises the following steps: step 1: placing the face frame 10 on the desktop in an inverted manner, and placing the multi-link keycap board 20 in the face frame 10 along the axial direction of the gaps 11 of the face frame 10, allowing the keycaps 21 to be matched and connected with the gaps 11 of the face frame 10, and the keycaps 21 are perfectly embedded in the gaps 11 of the face frame 10, allowing the face frame 10 to be in close fit with the multi-link keycap board 20; step 2: placing the metal shrapnel 30, the flexible circuit board 40 and the backplane 50 on the lower surface of the multi-link keycap board 20 in an inverted manner, and passing the rubber columns 12 of the face frame 10 through holes of the metal shrapnel 30, the flexible circuit board 40 and the backplane 50 successively, realizing accurate positioning and easy installation; and step 3: heating the rubber columns 12 to melt it together with the backplane 50. As the rubber columns 12 are made of a plastic material, rubber columns 12 will be melted and deformed after being heated, thus being fixed on the backplane 50. After cooling, all parts of the whole keyboard will be fitted more firmly and closely due to the principle of heat expansion and cold contraction. The assembly method of the keyboard provided by the examples of the invention is based on simplicity and rationalization of the keyboard structure, and the multi-link keycap board 20 and the metal shrapnel 30 are of integrated structure, and can be molded in an integrated manner respectively for automatic production, thus reducing the production cost, keeping assembly more convenient and efficient, ensuring the consistency of the products, and greatly improving the production efficiency and product assembly efficiency.

During use, as shown in FIGS. 1-3, the struts 211 on the lower end of the keycaps 21 abut against the arc-shaped obstacles 31 of the metal shrapnel 30 by pressing the keycaps 21 with a finger, so that the arc-shaped obstacles 31 are stressed and deformed, and come into contact with the flexible circuit board 40 to generate signal transmitted to the computer. After the finger is released, the keycaps 21 and the arc-shaped obstacles 31 will reset by the balancing elastic force of the multi-link structure 22 of the multi-link keycap board 20 and the elastic force of the metal shrapnel 30, and the flexible circuit board 40 will stop sending signal. In addition, during use, fingers often cannot accurately press the middle position of the keycaps 21. However, by using the keyboard of the example, when fingers presses a corner 212 of the keycaps 21 for application of force, another corner 213 of the diagonal will be under a counterforce from the face frame 10, the lower skirt 13 of the face frame 10 will transfer the force to the upper skirt 214 of the keycaps, and the multi-link structure 22 of the multi-link keycap board 20 will apply a counterforce to the keycaps 21 to ensure that the keycaps can move up and down easily and effortlessly. The keyboard provided in the examples of the invention solves the problem of thickness of the product, and tactile will be produced during use, thus the keyboard is more easily accepted by consumers. In addition, the keyboard provided in the examples of the invention saves the coast during production and assembly, improving the efficiency, thus the keyboard will be favored by the market.

The above mentioned examples are only preferred examples of the invention and not used to limit the invention. Any modification, equivalent replacement and improvement made within the range of the spirit and rule of the invention can be incorporated in the protection range of the invention.

What is claimed is:

1. A keyboard comprising a face frame, a multi-link keycap board, a metal shrapnel, a flexible circuit board and a backplane connected successively, the multi-link keycap board being of integrated self-balancing multi-link structure, and multiple keycaps being fixedly arranged on the multi-link structure, the metal shrapnel being of integrated structure, and arc-shaped obstacles being respectively arranged at the corresponding positions of the keycaps.

2. The keyboard according to claim 1 wherein multiple gaps matching the keycaps are arranged on the face frame, multiple rubber columns are arranged on the lower surface of the face frame, and holes corresponding to the rubber columns are respectively arranged on the metal shrapnel, the flexible circuit board and the backplane.

3. The keyboard according to claim 2 wherein some struts are fixedly arranged on the lower end of the keycaps, and the struts are in contact with the arc-shaped obstacles of the metal shrapnel.

4. The keyboard according to claim 3 wherein the backplane is a metal backplane.

5. The keyboard according to claim 1 wherein the multi-link structure comprises a side frame and multiple links, the shape of the links is corresponding to the keycaps, and both ends of the links are fixedly connected with the side frame.

6. An assembly method of the keyboard according to claim 2 comprising the following steps:
placing the face frame on the desktop in an inverted manner, and placing the multi-link keycap board in the face frame along the axial direction of the gaps on the face frame, allowing the keycaps to be matched and connected with the gaps on the face frame;
placing the metal shrapnel, the flexible circuit board and the backplane on the lower surface of the multi-link keycap board in an inverted manner, and passing the rubber columns of the face frame through holes of the metal shrapnel, the flexible circuit board and the backplane successively; and
heating the rubber columns to melt it together with the backplane.

7. An assembly method of the keyboard according to claim 3 comprising the following steps:
placing the face frame on the desktop in an inverted manner, and placing the multi-link keycap board in the face frame along the axial direction of the gaps on the face frame, allowing the keycaps to be matched and connected with the gaps on the face frame;
placing the metal shrapnel, the flexible circuit board and the backplane on the lower surface of the multi-link keycap board in an inverted manner, and passing the rubber columns of the face frame through holes of the metal shrapnel, the flexible circuit board and the backplane successively; and
heating the rubber columns to melt it together with the backplane.

8. An assembly method of the keyboard according to claim 4 comprising the following steps:
placing the face frame on the desktop in an inverted manner, and placing the multi-link keycap board in the face frame along the axial direction of the gaps on the face frame, allowing the keycaps to be matched and connected with the gaps on the face frame;
placing the metal shrapnel, the flexible circuit board and the backplane on the lower surface of the multi-link keycap board in an inverted manner, and passing the rubber columns of the face frame through holes of the metal shrapnel, the flexible circuit board and the backplane successively; and
heating the rubber columns to melt it together with the backplane.

9. An assembly method of the keyboard according to claim 5 comprising the following steps:
placing the face frame on the desktop in an inverted manner, and placing the multi-link keycap board in the face frame along the axial direction of the gaps on the face frame, allowing the keycaps to be matched and connected with the gaps on the face frame;
placing the metal shrapnel, the flexible circuit board and the backplane on the lower surface of the multi-link keycap board in an inverted manner, and passing the rubber columns of the face frame through holes of the metal shrapnel, the flexible circuit board and the backplane successively; and
heating the rubber columns to melt it together with the backplane.
